(19) United States
(12) Patent Application Publication
(10) Pub. No.: US 2012/0224175 A1
(43) Pub. Date: Sep. 6, 2012

(54) MICROWAVE PLASMA ATOMIC FLUORESCENCE MERCURY ANALYSIS SYSTEM

(76) Inventor: Philippe Minghetti, Hopewell Junction, NY (US)

(21) Appl. No.: 13/039,320

(22) Filed: Mar. 3, 2011

(51) Int. Cl. G01N 21/68

(52) U.S. Cl. 356/316; 250/458.1

(57) ABSTRACT

A method for the detection of mercury or other heavy metals in a gas stream comprises the steps of: providing a pulsed microwave power supply;

supplying a microwave generator with power from the pulsed microwave power supply; using the microwave generator to power a short circuited waveguide to create a plasma torch located in a chamber; feeding a sample of the gas stream to the plasma torch; using the plasma torch to transform oxidized elements in the gas stream to atomic elements; and analyzing by atomic fluorescence of the gas stream having the atomic elements with an excitation lamp for the presence of at least one metal.

### BACKGROUND OF THE INVENTION

1. Field of the Invention

The present invention relate to an on-line analysis method and system for detecting mercury and other heavy metals in emission gas from coal-fired power plants, or municipal waste incinerators, as well as in discharge water or natural water.

2. Description of Related Art

Mercury and other heavy metals like arsenic, lead, chromium, and beryllium are highly toxic. They are emitted in large quantities by a number of industries like coal-fired power plant and municipal waste incinerators. Consequently, national and international regulations require continuous emission monitoring systems (CEMs) for these industries. Additionally, emission reduction systems also require CEMs to control the efficiency of the process.

Existing systems are often based on standard methods that use wet-chemistry that requires too much maintenance for this kind of application.

Others are using a high temperature element with a catalyzer to transform oxidized elements to atomic elements. Theses catalyzes have a limited life-time which can result in unstable measurements.

Others are using a gold trap which introduces a memory effect and requires frequent replacement.

Other systems are based on emission spectroscopy which may not have sufficient sensitivity regarding the emission level after mercury reduction processes.

Detecting heavy metals in a gas is known in the prior art. More specifically, by way of example, U.S. Pat. No. 7,123,361 to Doughty discloses a micro-plasma emission spectrometer that includes a chamber for confining a sample volume of gas, a resonant antenna structure that generates a micro-plasma in the chamber from a sample volume of gas and an RF power supply that provides power to the resonant antenna structure.

U.S. Pat. No. 6,774,993 to Hudak discloses an atomic emission detector includes a solid state signal power source coupled to a resonant cavity and a spectrographic detector to sense atomic emissions from a gas within the resonant cavity.

U.S. Pat. No. 6,577,390 to Efthimion discloses an emissions monitor for the measurement of vapor phase and particulate-based metals in gas streams such as those at coal-fired utility plants in which a pulsed plasma source, utilizing a resonant reentrant microwave cavity which is powered by a microwave generator, operates at sub atmospheric pressures (<50 Torr.) by using a pump to eliminate quenching of the light emission processes

U.S. Pat. No. 6,538,734 to Powell discloses exciting a sampled gas to emit radiation and detecting in real time from the emitted radiation a plurality of wave bands of an emission spectrum. Energy used to excite the sampled gas may be adjusted based on the detected wave bands.

U.S. Pat. No. 6,429,935 to Duan discloses a microwave plasma torch which can either be contained within a sealed housing or can be operated in ambient air at ambient pressures. The microwave plasma torch is portable and can be operated continuously for real-time analysis of air.

U.S. Pat. No. 6,381,014 to Platzer, et al. discloses a device for generating plasma which is made up of two ring or disk-shaped parallel, interspaced electrodes, where each electrode has one circular through-opening, and an isolator positioned between said electrodes where the isolator has a particularly circular through-opening for confining the plasma.

U.S. Pat. No. 5,909,277 to Woskov et al. discloses a source of microwave energy directed onto a sample gas to create a plasma. A spectrometer is arranged to receive light from the plasma to identify different elements and/or to determine the concentration of at least one element in the sample gas.

U.S. Pat. No. 5,671,045 to Woskov, et al. discloses a sensor having a source of high power microwave energy and a shorted waveguide made of a microwave conductive, high temperature capability refractory material communicating with the source of the microwave energy to generate a plasma. The sensor is capable of making continuous, real time quantitative measurements of desired elements, such as the heavy metals lead and mercury.

U.S. Pat. No. 4,844,612 to Durr, et al. discloses apparatus for analyzing elements by inductive plasma spectrometry where the plasma production means includes means for circulating air in the tube to produce the plasma.

### SUMMARY OF THE INVENTION

In an exemplary embodiment of the present invention, there is disclosed a method for the detection of mercury or other heavy metals in a gas stream comprises the steps of:
providing a pulsed microwave power supply;
supplying a microwave generator with power from the pulsed microwave power supply;
using the microwave generator to power a short circuited waveguide to create a plasma torch located in a chamber;
feeding a sample of the gas stream to the plasma torch;
using the plasma torch to transform oxidized elements in the gas stream to atomic elements; and
analyzing by atomic fluorescence of the gas stream having the atomic elements with an excitation lamp for the presence of at least one metal.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a system used for on-line analysis of emission gas from coal fired power plants or municipal waste incinerators, as well as discharge water and the like for mercury and other heavy metals in accordance with the principles of the invention.

### DESCRIPTION OF THE PREFERRED EMBODIMENT

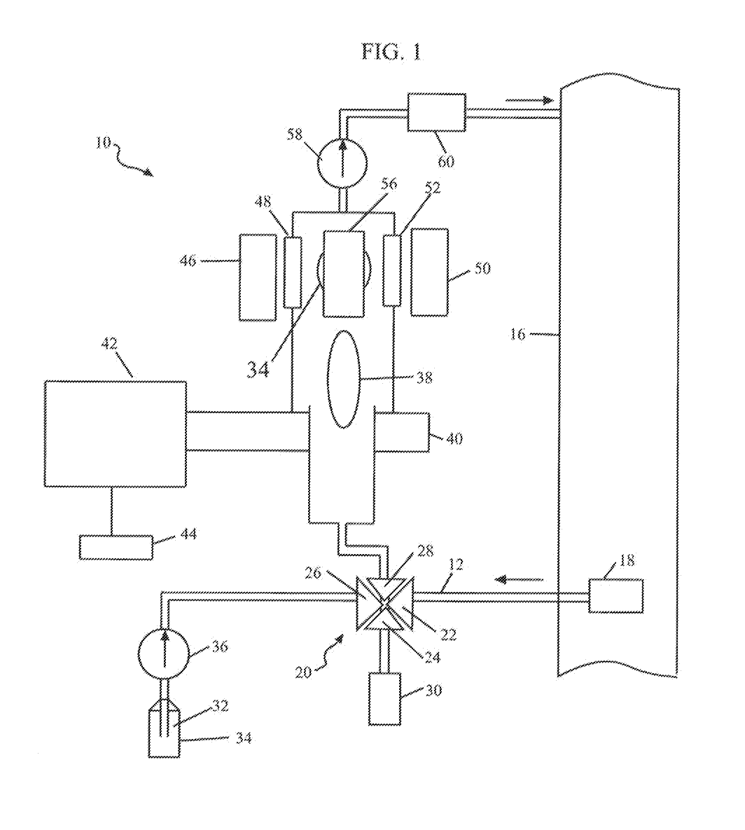

Referring to FIG. 1, there is shown a system 10 for on-line analysis of emission gas from coal fired power plants or municipal waste incinerators, as well as discharge water and the like for mercury and other heavy metals in accordance with the principles of the invention.

A suction pipe 12 which may be connected to a source of suction such as a suction pump 14 has an end located in a stack, duct or pipe 16 to extract a gas sample that is to be analyzed for the presence of mercury and/or other heavy metals. The gas that is to be analyzed and is extracted from a stack, duct or pipe 16 is passed through a filter 18 which is located at or downstream of the end of the suction pipe 12 and is provided to remove particles which may be present in the gas. The suction pipe 12 may also be heated with a source of heat (not shown) to prevent condensation of the gas that is passing through the suction pipe.

The down stream end of suction pipe 12 is connected to an input opening 22 of a three way valve 20 having three input openings 22, 24, 26 and one output opening 28. Input opening 24 is connected to receive a zero gas such as ambient air which has no heavy metals from the air through a filter 30. Input opening 26 is connected to an optional calibration system formed by a standard solution 32 located in a container 34 which contains the analyzed metallic element(s) which can be injected into the gas by a pump 36. When the invention disclose is used to analyze for water application, the solution 32 in the container 34 can be replaced with water.

The output opening 28 of the three way valve 20 is connected to feed a gas to a plasma torch 38 that transforms oxidized elements in the gas to atomic elements. The plasma torch is formed by a short circuited waveguide 40 powered by a microwave generator 42 which is supplied by a pulsed microwave power supply 44.

The oxidized elements which are transformed to atomic elements by the plasma torch located in a chamber are analyzed by atomic fluorescence using an excitation lamp 46 which transmits its light through a first window 48 in the chamber. The light transmitted through the first window is controlled by a photo detector 50 which is located in front of a second window 52 in the chamber and which is aligned with the first window. The fluorescent light is measured by a high sensibility photo detector 54 located in front of a third window 56 in the chamber which is not aligned with the first and second windows.

A pump 58 which is controlled by flow meter 60 is used to move the gas from the outlet opening of the three way valve 20 through the chamber with the plasma torch 38, and through the exhaust pipe 62 to the down stream flow of the gas in the stack, duct or pipe 16.

Heating elements, (not shown), are located to be in contact with parts of the structure to maintain the gas at a temperature that is above the dew point of the gas.

One or more atomic fluorescence detection channels can be added for multi-metals analysis.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for the detection of mercury or other heavy metals in a gas stream comprises the steps of:
providing a pulsed microwave power supply;
supplying a microwave generator with power from the pulsed microwave power supply;
using the microwave generator to power a short circuited waveguide to create a plasma torch located in a chamber;
feeding a sample of the gas stream to the plasma torch;
using the plasma torch to transform oxidized elements in the gas stream to atomic elements; and
analyzing by atomic fluorescence of the gas stream having the atomic elements with an excitation lamp for the presence of at least one metal.

2. The method of claim 1 wherein the excitation lamp is located outside of the chamber and light from the excitation lamp is directed to the gas in the chamber through a first window.

3. The method of claim 2 wherein the window is located in the chamber above the plasma torch.

4. The method of claim 3 wherein the light transmitted through the gas in the chamber is controlled by a photo detector located behind a second window in the chamber and aligned with the first window.

5. The method of claim 4 wherein the fluorescence of the gas is measured by a high sensibility photo detector located behind a third window in the chamber.

6. The method of claim 5 wherein the sample of the gas is from a stack, duct or pipe.

7. The method of claim 6 wherein a suction pump is located upstream of the chamber to suck a sample of the gas from the stack, duct or pipe through the chamber.

8. The method of claim 7 wherein a flow meter is located down stream of the suction pump to control the flow of the gas from the stack, duct of pipe.

9. The method of claim 5 wherein a three way valve is located upstream of the plasma torch to feed a sample of the gas stream, or ambient air, or air from a bottle to the plasma torch.

10. The method of claim 9 wherein the air in the bottle has no mercury or other heavy metals and is used for calibration purposes.

11. A system for the detection of mercury or other heavy metals in a gas stream comprising:
a pulsed microwave power supply;
means for supplying a microwave generator with power from the pulsed microwave power supply;
means for using the microwave generator to power a short circuited waveguide to create a plasma torch located in a chamber;
means for feeding a sample of the gas stream to the plasma torch; and
means for analyzing by atomic fluorescence of the gas stream having the atomic elements with an excitation lamp for the presence of at least one metal;
wherein the plasma torch transforms oxidized elements in the gas stream to atomic elements.

12. The system of claim 11 wherein the excitation lamp is located outside of the chamber and light from the excitation lamp is directed to the gas in the chamber through a first window.

13. The system of claim 12 wherein the window is located in the chamber above the plasma torch.

14. The system of claim 13 wherein the light transmitted through the gas in the chamber is controlled by a photo detector located behind a second window in the chamber and aligned with the first window.

15. The system of claim 14 wherein the fluorescence of the gas is measured by a high sensibility photo detector located behind a third window in the chamber.

16. The system of claim 15 wherein the sample of the gas is from a stack, duct or pipe.

17. The system of claim 16 wherein a suction pump is located upstream of the chamber to suck a sample of the gas from the stack, duct or pipe through the chamber.

18. The system of claim 17 wherein a flow meter is located down stream of the suction pump to control the flow of the gas from the stack, duct of pipe.

19. The system of claim 15 wherein a three way valve is located upstream of the plasma torch to feed a sample of the gas stream, or ambient air, or air from a bottle to the plasma torch.

20. The system of claim 19 wherein the air in the bottle has no mercury or other heavy metals and is used for calibration purposes.
